(19) United States
(12) Patent Application Publication
(10) Pub. No.: US 2025/0393096 A1
(43) Pub. Date: Dec. 25, 2025

(54) WIRELESS COMMUNICATION METHOD AND RELATED DEVICES

(71) Applicant: SHENZHEN TCL NEW TECHNOLOGY CO., LTD., Shenzhen, Guangdong (CN)

(72) Inventor: Yiwei DENG, Shenzhen, Guangdong (CN)

(73) Assignee: SHENZHEN TCL NEW TECHNOLOGY CO., LTD., Shenzhen, Guangdong (CN)

(21) Appl. No.: 18/877,745

(22) PCT Filed: Jun. 30, 2022
(86) PCT No.: PCT/CN2022/103046

§ 371 Date: Dec. 20, 2024

(51) Int. Cl. H04W 76/28; H04W 52/02; H04W 72/1273

(52) U.S. Cl. CPC H04W 76/28; H04W 52/0216; H04W 72/1273

(57) ABSTRACT

A wireless communication method and related devices are provided. The method, performed by a user equipment (UE), including being configured with one or more Discontinuous Reception (DRX) configurations, each DRX configuration comprising one or more drx-on durations matching one or more services. With this method, jitters of (XR) packets can be covered by drx-on durations, facilitating XR traffic service.

### TECHNICAL FIELD

The present application relates to wireless communication technologies, and more particularly, to wireless communication method, and related devices such as a user equipment (UE) and a base station (BS) (e.g., a gNB).

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN includes a set of base stations (BSs) which provide wireless links to the UEs located in cells covered by the base stations, and an interface to a core network (CN) which provides overall network control. The RAN and CN each conducts respective functions in relation to the overall network.

The 3GPP has developed the so-called Long-Term Evolution (LTE) system, namely, an Evolved Universal Mobile Telecommunication System Territorial Radio Access Network (E-UTRAN), for a mobile access network where one or more macro-cells are supported by base station knowns as an eNodeB or eNB (evolved NodeB). More recently, LTE is evolving further towards the so-called 5G or NR (new radio) systems where one or more cells are supported by base stations known as a next generation Node B called gNodeB (gNB).

The 5G New Radio (NR) standard will support a multitude of different services each with very different requirements. These services include Enhanced Mobile Broadband (eMBB) for high data rate transmission, Ultra-Reliable Low Latency Communication (URLLC) for devices requiring low latency and high link reliability and Massive Machine-Type Communication (mMTC) to support a large number of low-power devices for a long life-time requiring highly energy efficient communication.

EXtended Reality (XR) and Cloud Gaming are some of the most important 5G media applications under consideration in the industry. XR is an umbrella term for different types of realities and refers to all real-and-virtual combined environments and human-machine interactions generated by computer technology and wearable devices. It includes representative forms such as Augmented Reality (AR), Mixed Reality (MR) and Virtual Reality (VR) and the areas interpolated among them. A new Study Item Description (SID) on XR evaluation has been approved, the characteristics of XR traffic and challenges are summarized below:

High Data Rate with Limited Latency

For 3D VR videos with high resolution based on different frame rates, color codecs, bit-depths, compression rates and etc., the transmission date rate could be up to 60 Mbps and above with limited latency, around 10˜30 ms.

Non-Integer Period with Jitter

It has been agreed that 60 frames per second (fps) is baseline for both Downlink (DL) and Uplink (UL) video stream and 30 fps, 90 fps as well as 120 fps can be also optionally evaluated. Based on the formula of arrival time of packet, the corresponding periodicities are {33.33 ms, 16.67 ms, 11.11 ms, 8.33 ms}. In addition, there exists jitter characteristic for XR traffic arrival. According to RAN1 agreements, the jitter can be modeled as truncated Gaussian distribution with varying range of [−4,4] ms (baseline) or [−5,5] ms (optional).

### Varying Frame Size

In the field of video compression, three major frame types are defined through three different video algorithms with the following characteristics:
I-frames are the least compressible which can decode independently
P-frames can use previous frames to decompress and are more compressible than I-frames.
B-frames can use both previous and forward frames to get the highest amount of data compression.

There is a need to solve the problems raised when merging the XR services into cellular wireless communication, especially for XR service transmission in New Radio (NR).

### SUMMARY

The objective of the present application is to provide a wireless communication method and related devices for arranging drx-on durations to cover jitters of (XR) packets and/or power saving such as XR power saving.

In a first aspect, an embodiment of the present application provides a wireless communication method, performed by a user equipment (UE) in a network, the method including: being configured with one or more Discontinuous Reception (DRX) configurations, each DRX configuration comprising one or more drx-on durations matching one or more services.

In a second aspect, an embodiment of the present application provides a wireless communication method, performed by a user equipment (UE) in a network, the method including: being configured with Discontinuous Reception (DRX) and/or being configured with Configured Grant (CG) and/or Semi-Persistent Scheduling (SPS) occasions; and being configured with an additional drx-on duration or additional drx active time, after a CG Physical Uplink Shared Channel (PUSCH)/SPS Physical Downlink Shared Channel (PDSCH), wherein the additional drx-on duration or additional drx active time is triggered or not triggered.

In a third aspect, an embodiment of the present application provides a wireless communication method, performed by a user equipment (UE) in a network, the method including: being configured with Discontinuous Reception (DRX) and/or CG/SPS, and being indicated whether one or more Configured Grant (CG)/Semi-Persistent Scheduling (SPS) occasions are skipped during drx-on durations or whether a drx-retransmission occasion is skipped; and if the one or more CG/SPS occasions are skipped during the drx-on durations, not transmitting PUSCH or not receiving PDSCH on a CG/SPS configuration corresponding to the one or more CG/SPS occasions.

In a fourth aspect, an embodiment of the present application provides a wireless communication method, performed by a user equipment (UE) in a network, the method including: by a non-scheduling Downlink Control Information (DCI) scheduling no data transmission, being indicated with Physical Downlink Control Channel (PDCCH) adaptation associated with PDCCH skipping and search space group switching.

In a fifth aspect, an embodiment of the present application provides a wireless communication method, performed by by a base station (BS) in a network, the method including: configuring a user equipment (UE) with one or more Discontinuous Reception (DRX) configurations, each DRX configuration comprising one or more drx-on durations matching one or more services.

In a sixth aspect, an embodiment of the present application provides a wireless communication method, performed by a base station (BS) in a network, the method including: configuring user equipment (UE) Discontinuous Reception (DRX) and/or configuring the UE with Configured Grant (CG) and/or Semi-Persistent Scheduling (SPS) occasions; and configuring the UE with an additional drx-on duration or additional drx active time, after a CG Physical Uplink Shared Channel (PUSCH)/SPS Physical Downlink Shared Channel (PDSCH), wherein the additional drx-on duration or additional drx active time is triggered or not triggered.

In a seventh aspect, an embodiment of the present application provides a wireless communication method, performed by a base station (BS) in a network, the method including: configuring a user equipment (UE) with Discontinuous Reception (DRX) and/or CG/SPS, and indicating the UE whether one or more Configured Grant (CG)/Semi-Persistent Scheduling (SPS) occasions are skipped during drx-on durations or whether a drx-retransmission occasion is skipped; and if the one or more CG/SPS occasions are skipped during the drx-on durations, not receiving PUSCH or not transmitting PDSCH on a CG/SPS configuration corresponding to the one or more CG/SPS occasions.

In an eighth aspect, an embodiment of the present application provides a wireless communication method, performed by a base station (BS) in a network, the method including: by a non-scheduling Downlink Control Information (DCI) scheduling no data transmission, indicating a user equipment (UE) with Physical Downlink Control Channel (PDCCH) adaptation associated with PDCCH skipping and search space group switching.

In a ninth aspect, an embodiment of the present application provides a UE, including a processor configured to call and run program instructions stored in a memory, to execute the method of any of the first, the second, the third or the fourth aspect.

In a tenth aspect, an embodiment of the present application provides a BS, including a processor configured to call and run program instructions stored in a memory, to execute the method of any of the fifth, the sixth, the seventh or the eighth aspect.

In an eleventh aspect, an embodiment of the present application provides a computer readable storage medium provided for storing a computer program, which enables a computer to execute the method of any of the first to the eighth aspects.

In a twelfth aspect, an embodiment of the present application provides a computer program product, which includes computer program instructions enabling a computer to execute the method of any of the first to the eighth aspects.

In a thirteenth aspect, an embodiment of the present application provides a computer program, when running on a computer, enabling the computer to execute the method of any of the first to the eighth aspects.

### DESCRIPTION OF DRAWINGS

In order to more clearly illustrate the embodiments of the present application or related art, the following figures that will be described in the embodiments are briefly introduced. It is obvious that the drawings are merely some embodiments of the present application, a person having ordinary skill in this field can obtain other figures according to these figures without paying the premise.

FIG. 1 is a schematic block diagram illustrating a communication network system according to an embodiment of the present application.

FIG. 2 is a schematic diagram illustrating DRX mismatched with XR traffic with jitter.

FIG. 3 is a flowchart of a wireless communication method according to a first embodiment of the present application.

FIG. 4 is a schematic diagram illustrating drx-onDurationtimer with multiple values within DRX cycles according to an embodiment of the present application.

FIG. 5 is a schematic diagram illustrating sliding drx-onDurationtimer within DRX cycles according to an embodiment of the present application.

FIG. 6 is a schematic diagram illustrating sliding drx-onDurationtimer within a period according to an embodiment of the present application.

FIG. 7 is a schematic diagram illustrating drx-onDurationtimer configured with a large value to cover jitters according to an embodiment of the present application.

FIG. 8 is a schematic diagram illustrating drx-onDurationtimer with several parts having different PDCCH monitor occasions according to an embodiment of the present application.

FIG. 9 is a schematic diagram illustrating multiple DRX configurations according to an embodiment of the present application.

FIG. 10 is a schematic diagram illustrating one DRX configuration activated among multiple DRX configurations according to an embodiment of the present application.

FIG. 11 is a schematic diagram illustrating drx-onDurationtimer with modified the start according to an embodiment of the present application.

FIG. 12 is a flowchart of a wireless communication method according to a second embodiment of the present application.

FIG. 13 is a schematic diagram illustrating additional drx-ondurationtimer triggered by UCI according to an embodiment of the present application.

FIG. 14 is a schematic diagram illustrating the start of additional drx-ondurationtimer according to an embodiment of the present application.

FIG. 15 is a flowchart of a wireless communication method according to a third embodiment of the present application.

FIG. 16 is a schematic diagram illustrating drx-ReTransmissionTimer skipping according to an embodiment of the present application.

FIG. 17 is a schematic diagram illustrating drx-ReTransmissionTimer skipping based on delay according to an embodiment of the present application.

FIG. 18 is a flowchart of a wireless communication method according to a fourth embodiment of the present application.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present application are merely for describing the purpose of the certain embodiment, but not to limit the disclosure.

Following issues are identified for service traffic such as EXtended Reality (XR) service transmission.

Discontinuous Reception (DRX) is one of the efficient methods for User Equipment (UE) power saving. When UE steps into the DRX-OFF state, it will be suspended for Physical Downlink Control Channel (PDCCH) monitoring and can go to sleep for UE power saving. As discussed in Rel-17 RAN1 meeting, a truncated Gaussian distribution is used to model the jitter of DL and UL video stream for XR services. The range of jitter is agreed to be [−4, 4] ms (baseline) and [−5, 5] ms (optional). This means the XR packets may arrive at gNB or UE within a time window of 8 ms or 10 ms length, and the exact arrival time is not known in advance. When the XR traffic is arrived before DRX-ON, a scheduling grant will be monitored in DRX on duration timer. However, when the XR traffic is arrived after DRX-ON, UE needs to wait for a scheduling grant until next DRX cycle. This will a large latency will be caused. Some enhancements to handle the jitter of XR for DRX should be considered.

DRX is one of the efficient methods for UE power saving. When UE steps into the DRX-OFF state, it will be suspended for PDCCH monitoring and can go to sleep for UE power saving. In current 3GPP specification, UE is required to monitor PDSCH at the configured semi-persistent Scheduling (SPS) occasions regardless it is at DRX ON or OFF when DRX is configured. According to discussion on traffic model, mean packet size is very large. Taking AR/VR 60 Mbps as example, the mean packet size is 125000 bytes. To transmit so large Transport Block Size (TBS), more than one slots in time domain is needed. When DRX and/or SPS/Configured Grant (CG) are configured, a packet arrived before SPS/CG and a SPS/CG transmission occasion cannot transmit the packet completely. Then, a large latency will be caused if the UE waits for scheduling grant until next DRX on-duration. Some enhanced methods to solve this problem will be needed. In addition, the TB size of XR is varied in time. When SPS/CG resources are configured conservatively, large resources and power will be wasted. On the contrary, when SPS/CG resources are configured radically, a CG/SPS transmission occasion could not transmit a TB completely. Some enhanced methods to handle the issues should be considered.

In Rel-15/16/17, UE needs to monitor Physical Downlink Share Channel (PDSCH) at the configured SPS occasion regardless it is at DRX ON or OFF when DRX is configured. However, when UE in active time, receiving PDSCH on dynamic scheduling method has more flexibility on resources allocation and Hybrid Automatic Repeat request (HARQ) feedback. In addition, in some cases, when partial CG/SPS is overlapped with DRX active time, received PDSCH on SPS or transmitted Physical Uplink Share Channel (PUSCH) on CG will consume more energy. As a result, a method to skip SPS/CG should be considered.

In Rel-15/16/17, Physical Downlink Control Channel (PDCCH) adaption is indicated by a scheduling Downlink Control Information (DCI), which means PDCCH adaption can be triggered only by a DCI scheduling PDSCH/PUSCH. However, when there is no data to transmit or receive, PDCCH adaption does not trigger. In addition, in current 3GPP specification, at most 3 Radio Resource Control (RRC) values for PDCCH skipping duration could be indicated by DCI. However, in some cases, these values cannot match with XR services very well. For example, the values are too small or large. Some enhancement for the issues should be considered. The invention of this disclosure can be summarized as below:

1. When the XR traffic is arrived before DRX-ON, a scheduling grant will be monitored in DRX on duration timer. However, when the XR traffic is arrived after DRX-ON, UE needs to wait for a scheduling grant until next DRX cycle. This will cause a large latency. Some enhancements to handle the jitter of XR for CDRX should be considered.
Method 1: Multiple values of drx-onDurationtimer can be considered.
Method 2: Configuring a sliding drx-onDurationtimer. A set of time offsets and a reference or default value of drx-onDurationtimer can be configured to UE, wherein the time offset is used to indicate the start of drx-onDurationtimer, and the reference or default value is used to determine the actual duration of drx-onDurationtimer.
Method 3: Configuring a large value of drx-onDurationtimer. The value can cover the range of jitter, and some part of drx-onDurationtimer can be skipped.
Method 4: Configuring multiple active DRX configurations (a set of active DRX configurations). The set of DRX configurations include one or more than one DRX. A dynamic or semi-static way can be used to activate and switch DRX within the set,
Method 5: Configuring a set of negative integers, wherein the set of negative integers include one or more values. A signaling can indicate one of the values within the set and modify the start of next one or more drx-onDurationtimer.

2. When DRX and SPS/CG are configured, a packet arrived before SPS/CG and a SPS/CG transmission occasion can't transmit the packet completely, then a large latency will be caused if the UE waiting for scheduling until DRX on-duration. Some enhancement methods to solve this problem will be needed. In addition, the TB size of XR is varied in time, when SPS/CG resources are configured conservatively, large resources and power will be wasted, in the contrary, when SPS/CG resources are configured radically, a CG/SPS transmission occasion could not transmit a TB completely. Some enhanced methods to handle the issues should be considered.
Method 1: For CG, a default value for additional drx-ondurationtimer can be configured. UCI signaling can be used to trigger the addition drx-ondurationtimer, wherein the UCI is piggybacked on CG PUSCH. The duration of additional drx-on can be pre-configured by RRC signaling.
Method 2: For CG, a set of values of additional drx-ondurationtimer can be configured. UCI indicates one value from the set. The size of UCI is related to the size of the set. Each state of UCI can indicate a value within the set, wherein the UCI is piggybacked on CG PUSCH.

3. In current 3GPP specification, UE needs to monitor PDSCH at the configured SPS occasion regardless it is at DRX ON or OFF when DRX is configured. However, when UE is in active time, receiving PDSCH on dynamic scheduling method has more flexibility on resources allocation and HARQ-ACK feedback. In some cases, when partial CG/SPS is overlapped with DRX active time, received PDSCH on SPS or transmitted PUSCH on CG will consume more energy. As a result, a method to skipping SPS/CG should be considered.
Method 1: A default way can be used to indicate whether the CG/SPS can be skipped during the drx-onDurationtimer, wherein the CG/SPS can be skipped means UE does not transmit PUSCH or receive PDSCH on corresponding CG/SPS configuration (when a SPS is skipped, the HARQ feedback corresponding the SPS has also be skipped).
Method 2: A semi-static mechanism can be considered, introducing an RRC signaling to indicate whether the CG/SPS can be skipped during on drx-onDurationtimer or not.
Method 3: A scheduling DCI (e.g., UE-specific DCI) or non-scheduling DCI (e.g., group common DCI) are used to indicate whether CG/SPS or a set of CG/SPS or a part of CG/SPS can be skipped or not.

4. In current 3GPP specification, PDCCH adaption is indicated by a scheduling DCI, which means PDCCH adaption can be triggered only by a DCI scheduling PDSCH/PUSCH. However, when there is no data to transmit or receive, PDCCH adaption does not trigger. In addition, in current 3GPP specification, at most 3 RRC values for PDCCH skipping duration could be indicated by DCI. However, in some cases, the values cannot match with XR services very well. For example, the values are too small or large. Some enhancement for the issues should be considered.
A non-scheduling DCI to indicate the PDCCH adaptation. The size of the non-scheduling DCI can be configurable.
Reusing a reserved field in a scheduling DCI to indicate the PDCCH skipping. The reserved field can be re-defined as the remaining PDCCH skipping during a time duration.
Configuring a set of PDCCH skipping patterns for XR, and then a scheduling DCI or non-scheduling DCI can be used to indicate a value from the set.

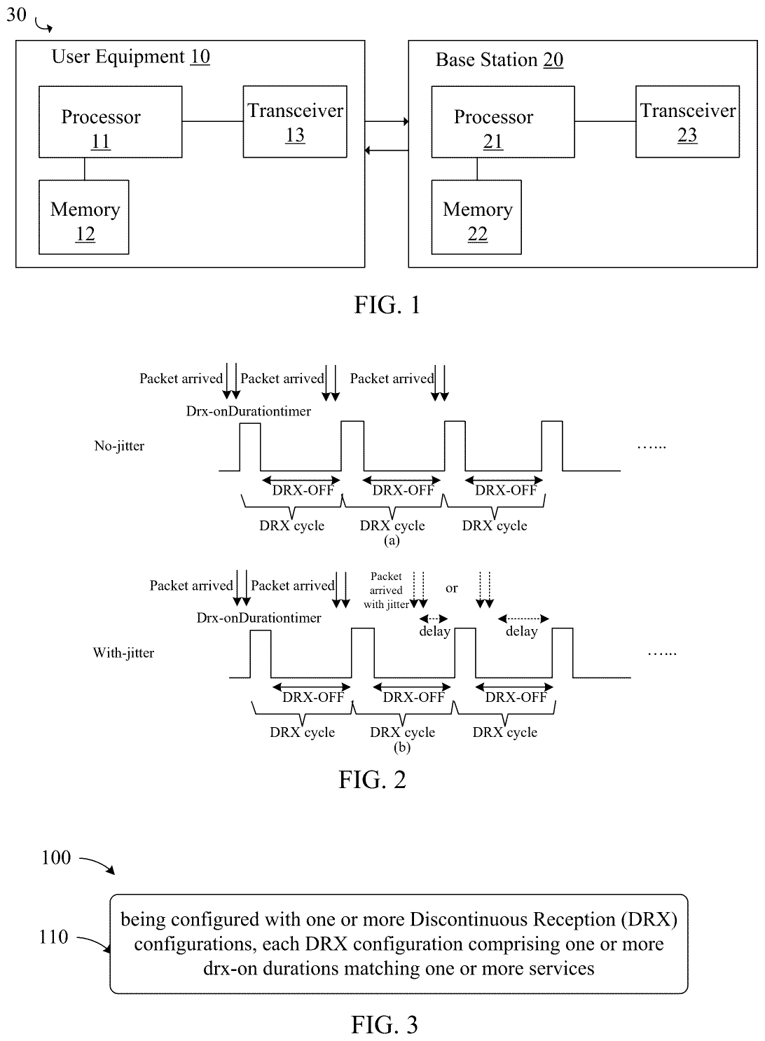

FIG. 1 illustrates that, in some embodiments, one or more user equipments (UEs) 10 and a base station (e.g., gNB or eNB) 20 for wireless communication in a communication network system 30 according to an embodiment of the present application are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

This disclosure proposes potential methods to handle the jitter of XR for DRX.

Configuring a DRX pattern with periodicity or some time offset(s) for a corresponding DRX cycle may help match with XR traffic. However, as shown in FIG. 2, when XR packet arrives with jitter, configuring a pattern or time offset(s) is not useful anymore. A large delay will be caused due to the jitter. To handle the jitter of XR for DRX, a straightforward way is to configure a large value of drx-onDurationTimer which can cover the range of jitter. However, a large value of drx-onDurationTimer will cause high power consumption. As a result, some potential enhancements should be considered.

FIG. 3 is a flowchart of a wireless communication method according to a first embodiment of the present application. Referring to FIG. 3 in conjunction with FIG. 1, the method 100 includes the following. In Step 110, the UE 10 is configured by the base station 20 with one or more Discontinuous Reception (DRX) configurations, each DRX configuration comprising one or more drx-on durations matching one or more services. With this method, jitters of (XR) packets can be covered by drx-on durations, facilitating XR traffic service.

The drx-on duration can be understood as drx-onDurationTimer when DRX is configured. The following descriptions are illustrated using “drx-onDurationtimer”. It should be noted that the term “drx-on duration” and “drx-onDurationTimer” are interchanged in most cases based on the spirit of the invention.

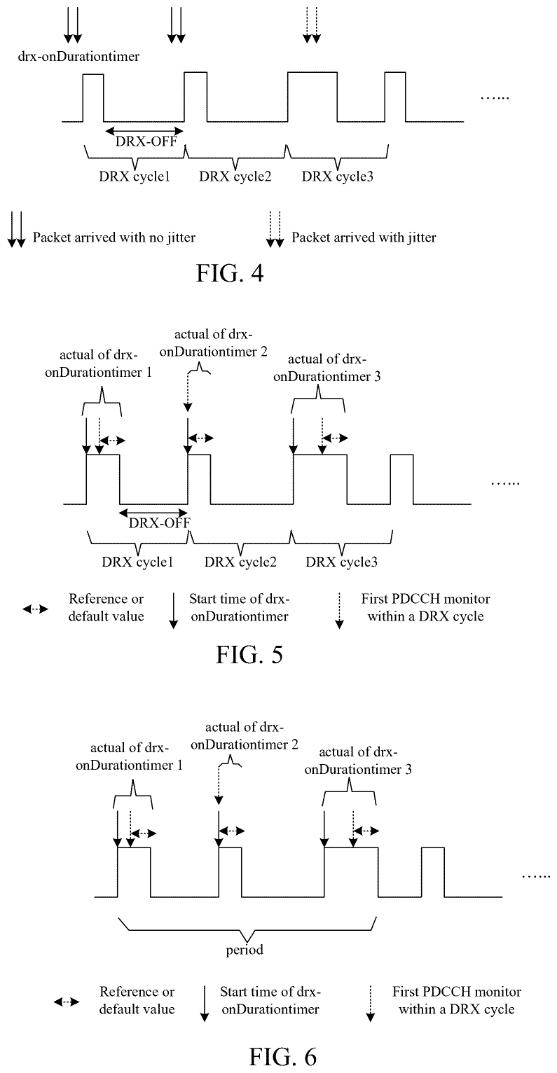

In a first possible implementation, multiple values of drx-onDurationtimer can be configured. With this method, when the packet arrives with no jitter, a regular drx-onDurationtimer for DRX cycles can be configured to UE, when the packet arrives with jitter, a non-regular drx-onDurationtimer for DRX cycles can be configured to UE. The non-regular drx-onDurationtimer is large than the regular drx-onDurationtimer in time length, and the DRX-on duration can cover the range of jitter. As shown in FIG. 4, a regular drx-onDurationtimer is configured to DRX cycle 1 and DRX cycle 2, a non-regular drx-onDurationtimer is configured to DRX cycle 3, and the value of non-regular drx-onDurationtimer is different with the regular drx-onDurationtimer. In some embodiments, the multiple values of drx-onDuration are cycled in DRX cycles.

In some embodiments, a fixed pattern can be configured to UE for XR services. Two type of drx-onDurationtimer can be considered. One is regular drx-onDurationtimer, and the other is non-regular drx-onDurationtimer. A set of values of drx-onDurationtimer can be configured to UE. The set of values of drx-ondurationtimer may include both regular and non-regular values of drx-onDurationtimer. A corresponding set of time offsets can also be configured to UE, wherein each drx-onDurationtimer within the set is associated to a corresponding value of time offset within the set. This pattern can cycle in time.

In some embodiments, a set of values of drx-onDurationtimer and a set of time offsets for the drx-onDurationtimer for a certain amount of cycles can be configured.

In some embodiments, a jitter time window can be introduced. Within the jitter time window, the drx-onDurationtimer is configured as non-regular drx-onDurationtimer (a default way), and regular drx-onDurationtimer can be used outside the jitter time window in time domain.

In a second possible implementation, if no PDCCH is detected during a drx-onDurationTimer, an additional drx active time or an additional drx-onDurationTimer will be triggered, wherein the additional drx active time or drx-onDurationTimer can be predefined. The drx active time means UE is awake or on active time, and UE monitors PDCCH during the active time. In some embodiments, the additional drx active time or drx-onDurationTimer is indicated by gNB. The starting of the additional drx active time or drx-onDurationTimer is indicated by gNB, this is similar to the determination on additional drx-on described in the following first possible implementation of the second embodiment, and please refer to the first possible implementation of the second embodiment for details.

In a third possible implementation, a sliding drx-onDurationtimer can be configured. A set of time offsets and a reference or default value of drx-onDurationtimer can be configured to UE, wherein the time offset is used to indicate the start of drx-onDurationtimer, and the reference or default value is used to determine the actual duration of drx-onDurationtimer. A new RRC signalling or drx-LongCycleStartOffset can be used to indicate the set of time offsets, and a new RRC signalling or drx-onDurationTimer in DRX-config can be used to indicate the reference or default value of drx-onDurationTimer.

In some embodiments, when sliding drx-onDurationtimer is enabled, a UE will be waked up at the start of the drx-onDurationtimer and starts to monitor PDCCH, denoted as time i. When a UE monitors a DCI at time j, then the actual drx-onDurationtimer starts from time i, and the duration of the drx-onDurationtimer is “the reference or default value+j−i+1” or “the reference or default value+j−i”. The unit of time i, j can be a symbol or slot or ms.

In some cases, a DRX cycle can be configured with a start of drx-onDurationtimer. UE wakes up at the start of time which is indicated by the time offset, as shown in FIG. 5. Take DRX cycle 3 as an example, the green arrow is the start of drx-onDurationtimer within DRX cycle3, red arrow is the time location a UE detects a PDCCH within DRX cycle 3. Then the actual of drx-onDurationtimer 3 (drx-onDurationtimer of DRX cycle 3) is equal to “time location of red arrow−time location of green arrow+1+reference or default value” or “time location of red arrow−time location of green arrow+reference or default value”, wherein the unit of time location and the reference or default value can be a symbol or slot or ms. That is, the reference is applied on a first PDCCH reception after the start of the drx-on duration.

In some cases, a drx-onDurationTimer pattern can be configured within a period, as shown in FIG. 6. The green arrows indicate the start of drx-onDurationtimer within the period, red arrows indicate the time location a UE detects a PDCCH within the period. Then the actual of one drx-onDurationtimer is equal to “time location of red arrow−time location of green arrow+1+reference or default value” or “time location of red arrow−time location of green arrow+reference or default value”, wherein the location of red arrow is the most recent PDCCH after the location of green arrow.

In some embodiments, an RRC signalling is introduced to enable or disable the function of sliding drx-onDurationtimer of DRX.

In some embodiments, the sliding drx-onDurationtimer is disabled when the following case is satisfied.
UE monitoring a PDCCH during the duration from the start of drx-onDurationtimer to “the start of drx-onDuratinotimer+reference or default value”.

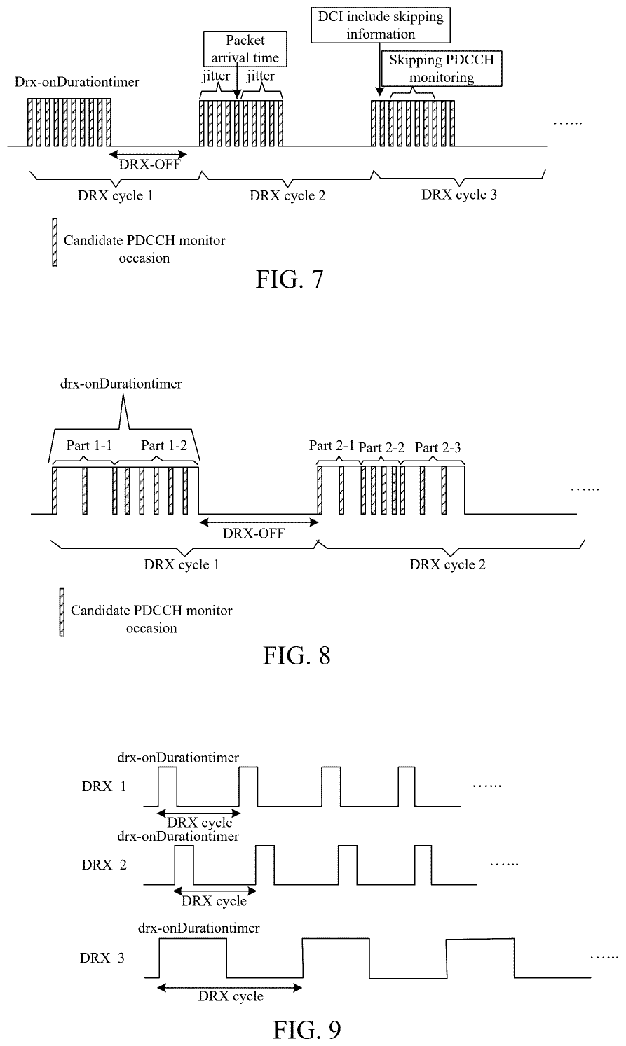

In a fourth possible implementation, a large value of drx-onDurationtimer is configured, and the value can cover the range of jitter, some parts of drx-onDurationtimer are skipped. As shown in FIG. 7, a large drx-onDurationTimer, DRX cycle2, is configured for covering jitter of XR. However, in this way, more power consumption will be caused due to the increased wake up time for UE. A DCI signalling can be used to indicate the PDCCH skipping, UE can go to sleep during the time duration of skipping, as shown in DRX cycle 3 in FIG. 7. When UE monitors a PDCCH skipping DCI, then UE can skip several PDCCH monitor occasions and can go sleeping during the duration. As shown in FIG. 7, some PDCCH monitor occasions of each drx-on duration are skipped in a discrete manner. The DCI can be a UE-specific DCI or a group common DCI or a new format DCI or a new RNTI scrambled DCI. In some embodiments, the PDCCH skipping indication signalling can be based on MAC-CE.

In some embodiments, the drx-onDurationtimer can be divided into several parts, and each part within the drx-onDurationtimer has its own PDCCH monitoring occasions (dense or sparse PDCCH monitoring occasions or different search space configuration). As shown in FIG. 8, the drx-onDurationTimer within DRX cycle 1 is divided into two parts, part 1-1 and part 1-2, part 1-1 has sparse PDCCH monitoring occasions, and part 1-2 has dense PDCCH monitoring occasions. The drx-onDurationTimer within DRX cycle 2 is divided into three parts, part 2-1, part 2-2 and part 2-3, part 2-1 and part 2-3 have sparse PDCCH monitoring occasions and part 2-2 has dense PDCCH monitoring occasions.

In some embodiments, the several parts and the corresponding PDCCH monitoring occasions are pre-configured, and cycle in time.

In some embodiments, the search space configuration of each several parts is different or the same.

In a fifth possible implementation, multiple active DRX configurations (a set active DRX configurations) are configured. The set of DRX configurations includes one or more DRXs. A dynamic or semi-static way can be used to activate or switch to a DRX configuration within the set, as shown in FIG. 9. Multiple active DRX configurations can solve the delay issue caused by jitter. UE should wake up at any drx-onDurationtimer within multiple active DRX configurations. For example, UE need wake up at any drx-onDurationTimer of DRX 1 and DRX 2 and DRX 3.

In some embodiments, dynamic activation of a set of DRX configurations can be considered, wherein the set of DRX configurations includes one or more DRXs. Activating the set of DRX configurations or de-activating the set of DRX configurations can be considered for saving DCI overhead. Introducing an index for each DRX (e.g., adding an information element (IE) in DRX-config) and configuring a DRX table for activation or de-activation of the multiple DRXs can be considered. Each row in the table includes one or more DRXs (e.g., index of DRX), the activation or de-activation of DCI indicates one row index of the table, and then a set of DRX configurations relating to the index should be activated or deactivated. The DCI can be a UE-specific DCI or a group common DCI or a new RNTI scrambled DCI or a new format DCI. In some embodiments, a set of DRXs can be activated or de-activated by MAC-CE.

In some embodiments, DRX configurations can be switched dynamically. A DCI includes both DRX configuration activation and de-activation information. For example, two fields in the DCI are used, one is used to activate DRX configurations, and the other one is used to de-activate DRX configurations. In some cases, if only one DRX can be activated at a time, when a new DRX is activated by a DCI, this means the current activated DRX configuration should be de-activated.

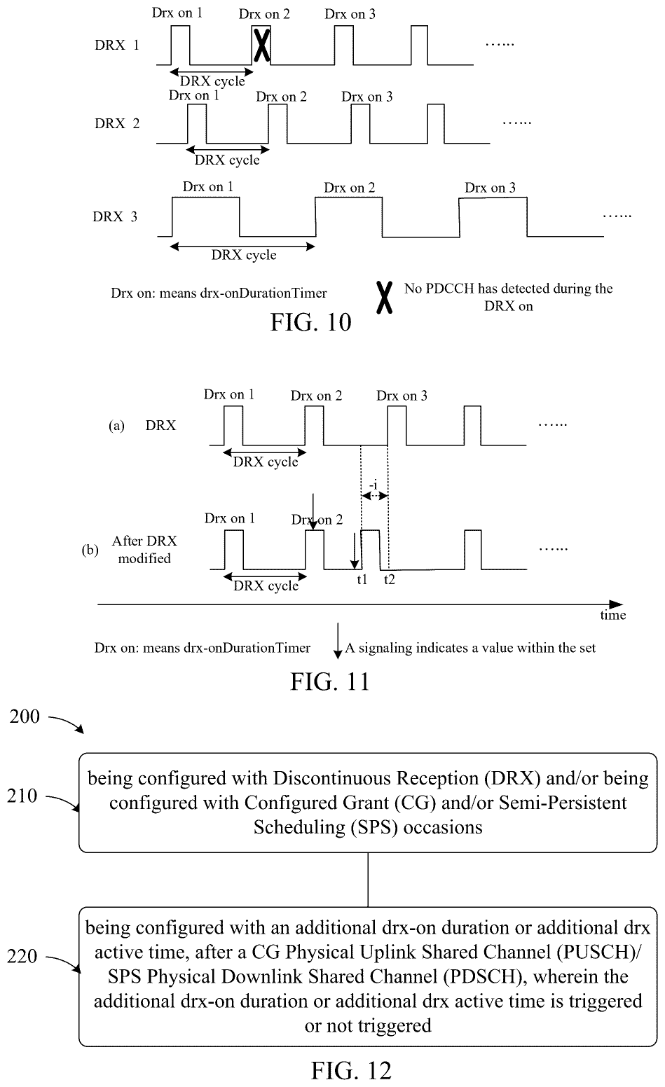

In some embodiments, multiple DRX configurations are configured, but only one of the DRX configurations is activated at a time. A default DRX configuration can be configured or a DCI activates one of the DRX configurations. If UE does not monitor any PDCCH on a drx-onDurationtimer within an active DRX configuration, then a closest DRX configuration among the multiple DRX configurations will be activated, wherein the closest DRX configuration is defined as the closest one to the currently activated DRX configuration with a drx-onDurationtimer within which no DCI is detected. UE needs to wake up at the start of a drx-onDurationtimer within the closest DRX configuration that corresponds to the drx-onDurationtimer of the currently activated DRX configuration within which no DCI is detected. When all related timers are running out, the closest DRX configuration will be de-activated. As shown in FIG. 10, three DRX configurations are configured. DRX 1 (representing DRX configuration 1) is configured as a default one or activated by DCI. When UE detects no PDCCH during the Drx on 2, then DRX 2 will be activated. UE needs to wake up at the start of Drx on 2 within DRX 2 and de-activates DXR 2 if the timer of Drx on 2 is running out.

In some embodiments, the drx-onDurationtimer within the closest DRX configuration is overlapped with the drx-onDurationtimer of the current active DRX configuration within which no DCI is detected. In some embodiments, the drx-onDurationtimer within the closest DRX configuration is not overlapped with the drx-onDurationtimer of the current active DRX configuration within which no DCI is detected.

In a sixth possible implementation, a set of negative integers are configured, wherein the set of negative integers include one or more negative values. A signalling can indicate one of the values within the set and modify the start of next one or more drx-onDurationtimer, as shown in FIG. 11. A DRX is configured, a base station (e.g., gNB) wants to modify the start of Drx on 3 and a signalling (before Drx on 3 or on Drx on 2) indicates a negative integer −i, and then the start of Drx on 3 (t1) is equal to: t2−i+1 or t2−i. In some embodiments, the granularity of t1 and t2 are symbol or slot or ms.

In some embodiments, the set of negative integers can be configured by RRC signalling. In some embodiments, the set of negative integers can dynamic indicated by DCI or MAC CE signalling. In some embodiments, the set of negative integers are configured by RRC signalling, and a DCI or MAC CE indicates one of the values within the set to UE.

In some embodiments, a set of integers can be configured, wherein the set of integers includes one or more positive or negative integers. A signalling can indicate one of the values within the set and modify the start of next one or more drx-onDurationtimer. If the value is a positive integer, it means the start of drx-onDurationtimer is postpone. if the value is a negative integer, it means the start of drx-onDurationtimer is advanced.

This disclosure proposes potential methods to trigger the additional transmission occasions for XR.

Low power consumption is important for several types of devices used for XR applications and Could Gaming, e.g., smart glasses, smartphones, and tablets. DRX is one of the efficient methods for UE power saving. When UE steps into the DRX-OFF state, it will be suspended for PDCCH monitoring and can go to sleep for UE power saving. In current 3GPP specification, UE is required to monitor PDSCH at configured Semi-Persistent Scheduling (SPS) occasions regardless it is at DRX ON or OFF when DRX is configured. When a UE is configured with DRX, the UE only monitor PDCCH in DRX-ON state. In addition, the UE can transmit PUSCH on Configured Grant (CG) resources. Assuming that a UE is configured with DRX and CG/SPS configuration, when the UE in DRX-OFF state and there is a large transport block (TB) arrived before a SPS transmission occasion, gNB could use the SPS to transmit the TB. Due to large in size, the SPS resource can only transmit part of the TB, the remaining parts of the TB need to be postponed until the UE turns to DRX-ON. However, large alignment delay will be caused. Potential methods to trigger additional active time can be considered.

FIG. 12 is a flowchart of a wireless communication method according to a second embodiment of the present application. Referring to FIG. 12 in conjunction with FIG. 1, the method 200 includes the following. In Step 210, the UE 10 is configured by the base station 20 with Discontinuous Reception (DRX) and/or being configured with Configured Grant (CG) and/or Semi-Persistent Scheduling (SPS) occasions. In Step 220, the UE 10 is configured by the base station 20 with an additional drx-on duration or additional drx active time, after a CG Physical Uplink Shared Channel (PUSCH)/SPS Physical Downlink Shared Channel (PDSCH), wherein the additional drx-on duration or additional drx active time is triggered or not triggered. With this method, latency is improved for XR services.

The drx active time means UE is awake or on active time, and UE monitors PDCCH during the active time.

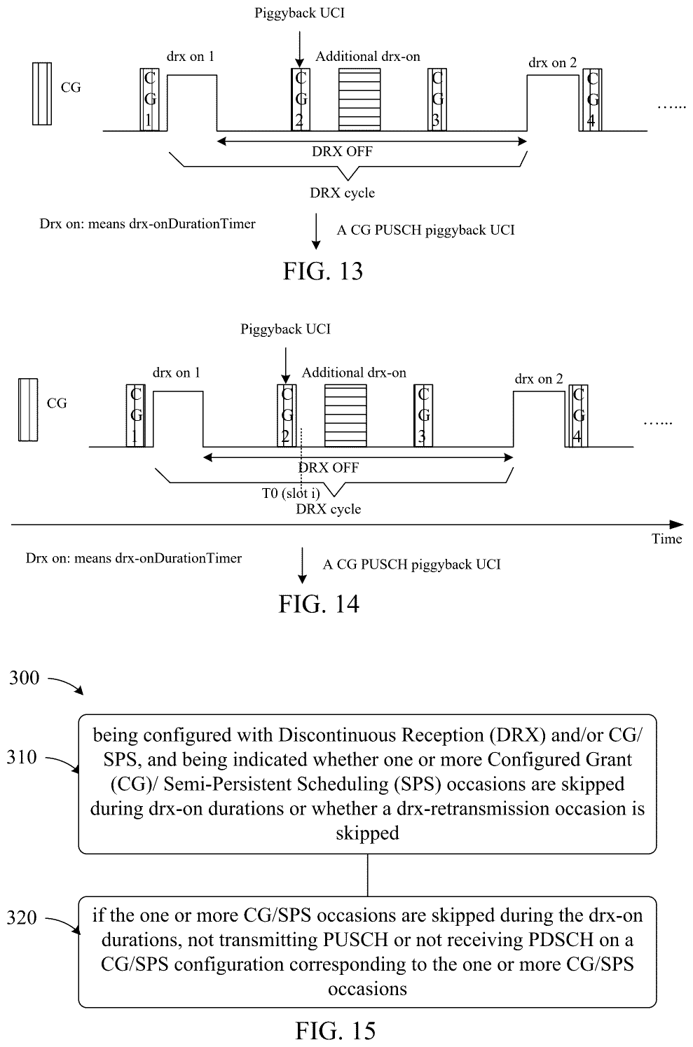

In a first possible implementation, for CG, a default value for additional drx-onDurationTimer can be configured. UCI signalling may be used to trigger the additional drx-ondurationtimer, wherein the UCI is piggybacked on CG PUSCH, and the duration of additional drx-on is pre-configured by RRC signalling. As shown in FIG. 13, when UE transmits a PUSCH on CG 2 and the PUSCH piggybacks a UCI to indicate whether to trigger additional drx-on (drx-onDurationtimer) or not. For instance, if only one default value of additional drx-onDuratinotimer is used, then the size of UCI is 1 bit. When the state of UCI is “1”, then it means the additional drx-ondurationtimer is triggered. When the state of UCI is “0”, it means the additional drx-ondurationtimer is not triggered.

In addition, the start of the additional drx-ondurationtimer should also be determined. Two ways can be considered:

1) the UCI indicates a value of k, wherein the k can be several of symbols or slots or ms. The reference point of the start of additional drx-ondurationtimer is based on the slot or the end slot or the start slot of CG PUSCH which piggybacks the UCI. As shown in FIG. 14, the start of the additional drx-onDurationtimer is at: slot i+k or slot i+k−1. In some embodiments, the reference point of the start of additional drx-ondurationtimer is based on the first symbol of the CG PUSCH which piggybacks the UCI or the last symbol of the CG PUSCH which piggybacks the UCI or the start symbol of the UCI or the end symbol of the UCI. The start of the additional drx-ondurationtimer is at: reference point +k or reference piont+k−1.

2) another way to determine of the start of additional drx-ondurationtimer is based on UE capacity type. Different types of UE have different processing time. The start time (e.g., slot) of the additional drx-onDurationTimer is the nearest slot which larger than the processing time, wherein the processing time is pre-defined, and the processing time is start from the end symbol of the CG PUSCH.

For SPS, a default value for additional drx-ondurationtimer can be configured. DCI signalling may be used to trigger the additional drx-ondurationtimer, wherein the DCI is piggybacked on SPS PDSCH. The duration of the additional drx-ondurationtimer is pre-configured by RRC signalling. Likewise, the methods to determine the start of additional drx-onDurationtimer for CG can also be used for SPS.

In some embodiments, whether to trigger an additional drx-onDurationtimer or not can be configured, and an RRC signalling can be used to enable or disable this function.

In a second possible implementation, for CG, a set of values of additional drx-ondurationtimer can be configured. UCI indicates one value from the set of values representing various durations of the additional drx-ondurationtimer. The size of UCI is related to the size of the set of values. Each state of UCI can indicate a value within the set, wherein the UCI is piggybacked on CG PUSCH. For instance, the number of the set of values is 4, and UCI size is 2 bits, as shown in table 1.

TABLE 1
relationship between UCI and the set

| UCI state | definition |
|---|---|
| 00 | The first value within the set |
| 01 | The second value within the set |
| 10 | The third value within the set |
| 11 | The fourth value within the set |

A similar way to determine the start of additional drx-onDurationtimer in above methods can be applied here.

For SPS, a set of values of additional drx-ondurationtimer can be configured. DCI indicates one value from the set of values. The size of DCI is related to the size of the set of values. Each state of DCI can indicate a value within the set, wherein the DCI is piggybacked on SPS PDSCH.

In some embodiments, whether to trigger an additional drx-onDurationtimer or not can be configured, and an RRC signalling can be used to enable or disable this function.

This disclosure proposes potential methods to skip the un-used CG/SPS transmission. In addition, a method regarding whether to trigger re-transmission timer should also be provided.

In current 3GPP specification, UE needs to monitor PDSCH at configured SPS occasions regardless it is at DRX ON or OFF when DRX is configured. However, when UE is in active time, receiving PDSCH with a dynamic scheduling method has more flexibility on resources allocation and HARQ-ACK feedback. As a result, a method to skip SPS/CG should be considered. In addition, when a CG/SPS is transmitted or received, a timer (e.g. drx-RetransmissionTimerUL or drx-RetransmissionTimerDL) which is used for re-transmission can be configured for making sure of reliability. However, the needs of BLER (Block Error Rate) for XR services is so low, correspondingly the re-transmission probability is also low. Large power consumption will be caused due to a duration wake up timer needed after every CG/SPS transmission occasion for UE. As a results, some enhanced methods to solve the issue can be studied.

FIG. 15 is a flowchart of a wireless communication method according to a third embodiment of the present application. Referring to FIG. 15 in conjunction with FIG. 1, the method 300 includes the following. In Step 310, the UE 10 is configured by the base station 20 with Discontinuous Reception (DRX) and/or CG/SPS, and is indicated whether one or more Configured Grant (CG)/Semi-Persistent Scheduling (SPS) occasions are skipped during drx-on durations or whether a drx-retransmission occasion is skipped. In Step 310, if the one or more CG/SPS occasions are skipped during the drx-on durations, not transmitting PUSCH or not receiving PDSCH on a CG/SPS configuration corresponding to the one or more CG/SPS occasions. With this method, XR power saving is achieved.

In a first possible implementation, a default way can be used to indicate whether one or more CG/SPS occasions can be skipped during the drx-onDurationtimer. The CG/SPS can be skipped means UE does not transmit PUSCH or receive PDSCH on corresponding CG/SPS configuration (when a SPS is skipped, the HARQ feedback corresponding the SPS has also be skipped). If the time domain resources of CG/SPS configuration are full overlapped with drx-onDurationTimer, then the CG/SPS configuration can be skipped. In some embodiments, if the time domain resources of CG/SPS configuration are overlapped with drx-onDuration Timer partly, the CG/SPS configuration can be skipped. In some embodiments, if the time domain resources of CG/SPS configuration are full overlapped with DRX active time, then the CG/SPS configuration can be skipped. In some embodiments, if the time domain resources of CG/SPS configuration are overlapped with DRX active time partly, the CG/SPS configuration can be skipped.

In a second possible implementation, a semi-static mechanism can be considered, introducing an RRC signalling to indicate whether one or more CG/SPS occasions can be skipped during on drx-onDurationtimer or not. If the RRC signalling indicates the CG/SPS skipping as “disable”, then UE needs to transmit PUSCH and receive PDSCH on every CG/SPS configuration. If the RRC signalling indicates CG/SPS skipping as “enable”, then UE needs to skip CG/SPS during the drx-onDurationtimer. The CG/SPS skipping means UE does not transmit PUSCH or receive PDSCH on corresponding CG/SPS configuration (when a SPS is skipped, the HARQ feedback corresponding the SPS has also be skipped). If the time domain resources of CG/SPS configuration are full overlapped with drx-onDurationTimer, then the CG/SPS configuration can be skipped. In some embodiments, if the time domain resources of CG/SPS configuration are overlapped with drx-onDurationTimer partly, the CG/SPS configuration can be skipped. In some embodiments, if the time domain resources of CG/SPS configuration are full overlapped with DRX active time, then the CG/SPS configuration can be skipped. In some embodiments, if the time domain resources of CG/SPS configuration are overlapped with DRX active time partly, the CG/SPS configuration can be skipped.

In a third possible implementation, a scheduling DCI (scheduling data transmission) (e.g., UE-specific DCI) or non-scheduling DCI (scheduling no data transmission) (e.g., group common DCI) are used to indicate whether CG/SPS or a set of CG/SPS or a part of CG/SPS can be skipped or not. In some embodiments, MAC CE or a DCI piggyback by PDSCH or UCI piggyback by PUSCH can be used to indicate whether CG/SPS or a set of CG/SPS or a part of CG/SPS can be skipped or not.

To further saving UE power consumption, when a CG/SPS is transmitted or received (DRX has also configured), a timer (e.g. drx-RetransmissionTimerUL or drx-RetransmissionTimerDL) which is used for re-transmission can be optimized.

In general, the re-transmission probability of a XR TB is very low (0.01 or 0.001), so in majority of re-transmission time, UE does not need to wake up. In current 3GPP specification, if the RetransmissionTimerUL or drx-RetransmissionTimerDL is configured, UE needs to wake up for detecting re-transmission grant after a CG/SPS is transmitted/received. However, with this mechanism, large power consumption will be caused. As a result, how to skip the drx-RetransmissionTimer of DL/UL can be studied.

In a first alternate implementation, a RRC signalling to enable or disable the Re-transmission time skipping of CG/SPS is introduced. If the RRC signalling configures as “enable”, it means UE can skip the drx-ReTransmissionTimer on DL/UL after a CG is transmitted or a SPS is received. If the RRC signalling configures as “disable”, it means UE can not skip the drxReTransmissionTimer on DL/UL after a CG is transmitted or a SPS is received.

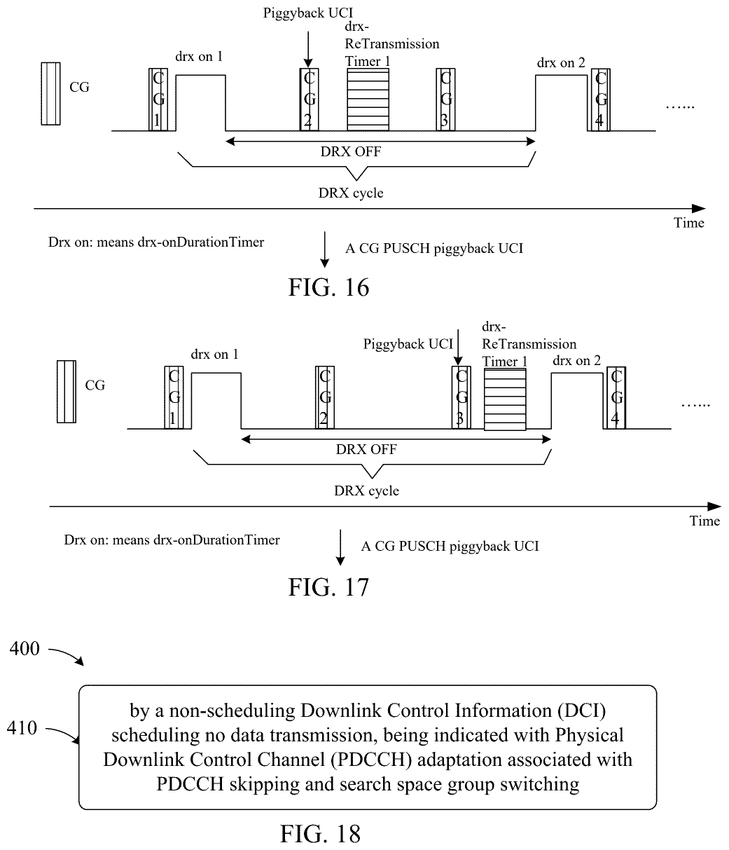

In a second alternate implementation, for CG configuration, whether to skip the drx-ReTransmissionTimerUL can be indicated by UCI. The UCI is piggybacked on CG PUSCH. For example, assuming the UCI size is 1 bit, if the UCI indicates “1”, it means the UE can skip the drx-ReTransmissionTimerUL after a CG is transmission. If the UCI indicates “0”, it means the UE can not skip the drx-ReTransmissionTimerUL after a CG is transmission. As shown in FIG. 16, if the UCI indicates as “1”, then the drx-ReTransmissionTimer 1 will be skipped.

For SPS configuration, whether to skip the drx-ReTransmissionTimerDL can be indicated by DCI. The DCI is piggybacked on SPS PDSCH. For example, assuming the DCI size is 1 bit, if the DCI indicates “1”, it means the UE can skip the drx-ReTransmissionTimerDL after a SPS is received. If the UCI indicates “0”, it means the UE can not skip the drx-ReTransmissionTimerdL after a SPS is received.

In a third alternate implementation, whether the drx-ReTransmissionTimerDL/UL is skipped or not is based on the Packet Delay Budget (PDB) and the time duration between the last symbol or slot of CG/SPS and the next drx-onDurationTimer. If the delay is large than a threshold, then UE can not skip drx-ReTransmissionTimerDL/UL. If the delay is small than a threshold, then UE can skip drx-ReTransmissionTimerDL/UL. The delay is defined as time duration between the last symbol of CG/SPS and the start symbol of the drx-onDurationTimer which is next to the CG/SPS. The threshold or the packet delay budget can be pre-defined. Take CG as an example, as shown in FIG. 17, if the delay is large than the packet delay budget, then UE can not skip drx-ReTransmissionTimer1; if the delay is small than the packet dealy budget, then UE can skip drx-ReTransmissionTimer1.

This disclosure proposes potential methods for PDCCH adaptation (PDCCH skipping and search space group switching) by non-scheduling DCI. In current 3GPP specification, PDCCH adaptation is based on a scheduling DCI, and non-scheduling DCI is not supported. It means PDCCH adaptation does not perform when no data is transmitted. However, this is not friendly for power saving and latency sensitive traffic. In addition, in current 3GPP specification, at most 3 RRC values for PDCCH skipping duration could be indicated by DCI. However, in some cases, the values does not match with XR services very well. For example, the values are too small or large.

FIG. 18 is a flowchart of a wireless communication method according to a fourth embodiment of the present application. Referring to FIG. 18 in conjunction with FIG. 1, the method 400 includes the following. In Step 410, by a non-scheduling Downlink Control Information (DCI) scheduling no data transmission, the UE 10 is indicated with Physical Downlink Control Channel (PDCCH) adaptation associated with PDCCH skipping and search space group switching. With this method, PDCCH adaptation is enhanced.

The following methods can be considered for PDCCH adaption. 1. A non-scheduling DCI is used to indicate the PDCCH adaptation, and the size of the non-scheduling DCI can be configurable. 2. A reserved field can be used in a scheduling DCI to indicate the PDCCH skipping. The reserved field can be re-defined as the remaining PDCCHs after skipped during a time duration, wherein the time duration can be pre-defined or the remaining duration of a drx-onDurationTimer or the remaining duration of drx active time. 3. A set of PDCCH skipping patterns are configured for XR, and then a scheduling DCI or non-scheduling DCI can be used to indicate a value from the set.

Commercial interests for some embodiments are as follows. 1. Solving issues in the prior art. 2. Facilitating XR traffic service. 3. Improving latency is improved. 4. Improving XR power saving. 5. Enhancing PDCCH adaptation 6. Providing a good communication performance. Some embodiments of the present application are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present application are a combination of “techniques/processes” that can be adopted in 3GPP specification to create an end product. Some embodiments of the present application could be adopted in the 5G NR unlicensed band communications. Some embodiments of the present application propose technical mechanisms.

The embodiment of the present application further provides a computer readable storage medium for storing a computer program. The computer readable storage medium enables a computer to execute corresponding processes implemented by the UE/BS in each of the methods of the embodiment of the present application. For brevity, details will not be described herein again.

The embodiment of the present application further provides a computer program product including computer program instructions. The computer program product enables a computer to execute corresponding processes implemented by the UE/BS in each of the methods of the embodiment of the present application. For brevity, details will not be described herein again.

The embodiment of the present application further provides a computer program. The computer program enables a computer to execute corresponding processes implemented by the UE/BS in each of the methods of the embodiment of the present application. For brevity, details will not be described herein again.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different approaches to implement the described functions for each particular application, but it should not be considered that the implementation goes beyond the scope of the present application.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1-21. (canceled)

22. A wireless communication method, performed by a user equipment (UE) in a network, the method comprising:
being configured with Discontinuous Reception (DRX) and Configured Grant (CG), and being indicated whether one or more Configured Grant (CG) occasions are skipped during drx-on durations or whether a drx-retransmission occasion is skipped; and
skipping one or more CG occasions during the drx-on durations if the one or more CG occasions are indicated skipped.

23. The method of claim 22, wherein an RRC signalling is used to indicate whether the one or more CG occasions are skipped during the drx-on durations.

24. The method of claim 22, wherein if time domain resources of the CG configuration are fully overlapped with the drx-on durations or DRX active time, the one or more CG occasions corresponding to the CG configuration are skipped.

25. The method of claim 22, wherein if time domain resources of the CG configuration are at partially overlapped with the drx-on durations or DRX active time, the one or more CG occasions corresponding to the CG configuration are skipped.

26. The method of claim 22, wherein an RRC signalling is used to indicate whether the UE skips the drx-retransmission occasion on uplink (UL) after a CG is transmitted or on downlink (DL) after a SPS is received.

27. The method of claim 22, wherein Uplink Control Information (UCI) piggybacked on CG PUSCH or Downlink Control Information (DCI) piggybacked on SPS PDSCH indicates whether to skip the drx-retransmission occasion after the CG PUSCH is transmitted.

28. The method of claim 22, wherein whether the drx-retransmission occasion is skipped or not is based on a Packet Delay Budget (PDB) and a time duration between a last symbol or slot of a CG before the drx-retransmission occasion and a next drx-on duration.

29. A wireless communication method, performed by a user equipment (UE) in a network, the method comprising:
by a non-scheduling Downlink Control Information (DCI) scheduling no data transmission, being indicated with Physical Downlink Control Channel (PDCCH) adaptation associated with PDCCH skipping and search space group switching.

30. The method of claim 29, further comprising:
being indicated with the PDCCH adaptation by a scheduling DCI scheduling data transmission,
wherein a field of the scheduling DCI indicates remaining PDCCHs after skipped during a time duration, which is a remaining duration of a drx-on duration or drx active time.

31. The method of claim 29, further comprising:
being configured with a set of PDCCH skipping patterns, wherein non-scheduling DCI or a scheduling DCI is used to indicate one of the set of PDCCH skipping patterns.

32-52. (canceled)

53. A wireless communication method, performed by a base station (BS) in a network, the method comprising:
configuring a user equipment (UE) with Discontinuous Reception (DRX) and Configured Grant (CG), and indicating the UE whether one or more occasions are skipped during drx-on durations or whether a drx-retransmission occasion is skipped; and
skipping one or more CG occasions during the drx-on durations if the one or more CG occasions are indicated skipped.

54. The method of claim 53, wherein an RRC signalling is used to indicate whether the one or more CG occasions are skipped during the drx-on durations.

55. The method of claim 53, wherein if time domain resources of the CG configuration are fully overlapped with the drx-on durations or DRX active time, the one or more CG occasions corresponding to the CG configuration are skipped.

56. The method of claim 53, wherein if time domain resources of the CG configuration are at partially overlapped with the drx-on durations or DRX active time, the one or more CG occasions corresponding to the CG configuration are skipped.

57. The method of claim 53, wherein an RRC signalling is used to indicate whether the UE skips the drx-retransmission occasion on uplink (UL) after a CG is transmitted or on downlink (DL) after a SPS is received.

58. The method of claim 53, wherein Uplink Control Information (UCI) piggybacked on CG PUSCH or Downlink Control Information (DCI) piggybacked on SPS PDSCH indicates whether to skip the drx-retransmission occasion after the CG PUSCH is transmitted.

59. The method of claim 53, wherein whether the drx-retransmission occasion is skipped or not is based on a Packet Delay Budget (PDB) and a time duration between a last symbol or slot of a CG before the drx-retransmission occasion and a next drx-on duration.

60-62. (canceled)
